(19) United States
(12) Patent Application Publication
(10) Pub. No.: US 2022/0414959 A1
(43) Pub. Date: Dec. 29, 2022

(54) Method for Training Virtual Image Generating Model and Method for Generating Virtual Image

(71) Applicant: Beijing Baidu Netcom Science Technology Co., Ltd., Beijing (CN)

(72) Inventors: Haotian PENG, Beijing (CN); Chen ZHAO, Beijing (CN)

(21) Appl. No.: 17/939,301

(22) Filed: Sep. 7, 2022

(30) Foreign Application Priority Data
Dec. 8, 2021 (CN) 202111488232.2

(51) Int. Cl. G06T 11/60; G06V 10/774; G06V 10/82; G06V 10/776

(52) U.S. Cl. CPC G06T 11/60; G06V 10/774; G06V 10/82; G06V 10/776

(57) ABSTRACT

A method and apparatus for training a virtual image generating model, a method and apparatus for generating a virtual image, a device, a storage medium, and a computer program product are provided. The method for training a virtual image generating model includes: training a first initial model using a standard image sample set and a random vector sample set as first of sample data, to obtain an image generating model; training a second initial model using a test latent vector sample set and a test image sample set as second sample data, to obtain an image encoding model; training a third initial model using a standard image sample set and a descriptive text sample set as third sample data, to obtain an image editing model; and training a fourth initial model using the third sample data based on the above models, to obtain the virtual image generating model.

### CROSS-REFERENCE TO RELATED APPLICATIONS

The present application claims the priority of Chinese Patent Application No. 202111488232.2, titled “METHOD FOR TRAINING VIRTUAL IMAGE GENERATING MODEL AND METHOD FOR GENERATING VIRTUAL IMAGE”, filed on Dec. 8, 2021, the content of which is incorporated herein by reference in its entirety.

### TECHNICAL FIELD

The present disclosure relates to the technical field of artificial intelligence, specifically relates to the technical fields of virtual/augmented reality, computer vision, and deep learning, may be applied to a scenario such as virtual image generation, and more specifically relates to a method and apparatus for training a virtual image generating model, a method and apparatus for generating a virtual image, a device, a storage medium, and a computer program product.

### BACKGROUND

At present, the generation of a virtual image from a text can be implemented only by matching, i.e., annotating the virtual image with an attribute tag manually, and manually setting a mapping relationship. However, this approach is costly and less flexible. For a large number of complex semantic structures, it is difficult to establish a grid-pattern mapping relationship with a deeper level by manual annotation.

### SUMMARY

The present disclosure provides a method for training a virtual image generating model, a method for generating a virtual image, an apparatus for training a virtual image generating model, an apparatus for generating a virtual image, a device, a storage medium, and a computer program product, thereby improving the virtual image generation efficiency.

Some embodiments of the present disclosure provide a method for training a virtual image generating model, including: acquiring a standard image sample set, a descriptive text sample set, and a random vector sample set; training a first initial model using the standard image sample set and the random vector sample set as first sample data, to obtain an image generating model; obtaining a test latent vector sample set and a test image sample set based on the random vector sample set and the image generating model; training a second initial model using the test latent vector sample set and the test image sample set as second sample data, to obtain an image encoding model; training a third initial model using the standard image sample set and the descriptive text sample set as third sample data, to obtain an image editing model; and training a fourth initial model using the third sample data based on the image generating model, the image encoding model, and the image editing model, to obtain the virtual image generating model.

Some embodiments of the present disclosure provide a method for generating a virtual image, including: receiving a request for generating a virtual image; determining a first descriptive text based on the request for generating a virtual image; and generating a virtual image corresponding to the first descriptive text based on the first descriptive text, a standard image that is pre-set, and a pre-trained virtual image generating model.

Some embodiments of the present disclosure provide an apparatus for training a virtual image generating model, including: a first acquiring module configured to acquire a standard image sample set, a descriptive text sample set, and a random vector sample set; a first training module configured to train a first initial model using the standard image sample set and the random vector sample set as first sample data, to obtain an image generating model; a second acquiring module configured to obtain a test latent vector sample set and a test image sample set based on the random vector sample set and the image generating model; a second training module configured to train a second initial model using the test latent vector sample set and the test image sample set as second sample data, to obtain an image encoding model; a third training module configured to train a third initial model using the standard image sample set and the descriptive text sample set as third sample data, to obtain an image editing model; and a fourth training module configured to train a fourth initial model using the third sample data based on the image generating model, the image encoding model, and the image editing model, to obtain the virtual image generating model.

Some embodiments of the present disclosure provide an apparatus for generating a virtual image, including: a first receiving module configured to receive a request for generating a virtual image; a first determining module configured to determine a first descriptive text based on the request for generating a virtual image; and a first generating module configured to generate a virtual image corresponding to the first descriptive text based on the first descriptive text, a standard image that is pre-set, and a pre-trained virtual image generating model.

Some embodiments of the present disclosure provide an electronic device, including: at least one processor; and a memory communicatively connected to the at least one processor; where the memory stores instructions executable by the at least one processor, and the instructions are executed by the at least one processor, such that the at least one processor can execute the above method for training a virtual image generating model and the above method for generating a virtual image.

Some embodiments of the present disclosure provide a non-transitory computer readable storage medium storing computer instructions, where the computer instructions are used for causing the above computer to execute the above method for training a virtual image generating model and the above method for generating a virtual image.

Some embodiments of the present disclosure provide a computer program product, including a computer program, where the computer program, when executed by a processor, implements the above method for training a virtual image generating model and the above method for generating a virtual image.

It should be understood that contents described in the summary are neither intended to identify key or important features of embodiments of the present disclosure, nor intended to limit the scope of the present disclosure. Other features of the present disclosure will become readily understood with reference to the following description.

### BRIEF DESCRIPTION OF THE DRAWINGS

The accompanying drawings are used for better understanding of the present solution, and do not impose any limitation on the present disclosure. In the drawings:

FIG. 1 is a diagram of an exemplary system architecture in which embodiments of the present disclosure may be implemented;

FIG. 2 is a flowchart of a method for training a virtual image generating model according to an embodiment of the present disclosure;

FIG. 3 is a flowchart of the method for training a virtual image generating model according to another embodiment of the present disclosure;

FIG. 4 is a schematic diagram of generating a shape coefficient by a shape coefficient generating model according to the present disclosure;

FIG. 5 is a flowchart of training a first initial model using a standard image sample set and a random vector sample set as first sample data, to obtain an image generating model according to an embodiment of the present disclosure;

FIG. 6 is a flowchart of training a second initial model using a test hidden vector sample set and a test image sample set as second sample data, to obtain an image encoding model according to an embodiment of the present disclosure;

FIG. 7 is a flowchart of training a third initial model using a standard image sample set and a descriptive text sample set as third sample data, to obtain an image editing model according to an embodiment of the present disclosure;

FIG. 8 is a flowchart of training a fourth initial model using the third sample data, to obtain a virtual image generating model according to an embodiment of the present disclosure;

FIG. 9 is a flowchart of a method for generating a virtual image according to an embodiment of the present disclosure;

FIG. 10 is a schematic structural diagram of an apparatus for training a virtual image generating model according to an embodiment of the present disclosure;

FIG. 11 is a schematic structural diagram of an apparatus for generating a virtual image according to an embodiment of the present disclosure; and

FIG. 12 is a block diagram of an electronic device configured to implement the method for training a virtual image generating model or the method for generating a virtual image of embodiments of the present disclosure.

### DETAILED DESCRIPTION OF EMBODIMENTS

Example embodiments of the present disclosure are described below with reference to the accompanying drawings, including various details of the embodiments of the present disclosure to contribute to understanding, which should be considered merely as examples. Therefore, those of ordinary skills in the art should realize that various alterations and modifications may be made to the embodiments described here without departing from the scope and spirit of the present disclosure. Similarly, for clearness and conciseness, descriptions of well-known functions and structures are omitted in the following description.

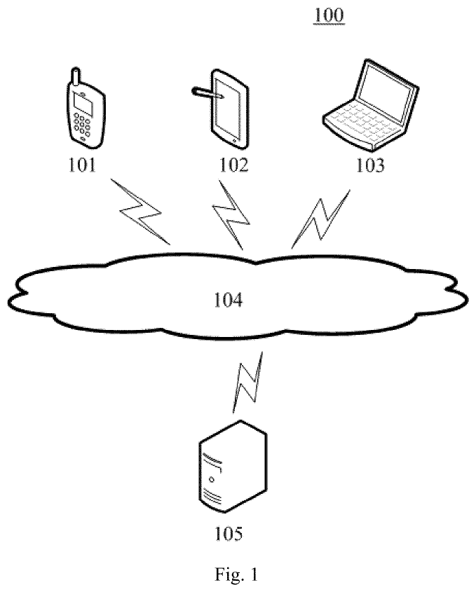

FIG. 1 shows an exemplary system architecture 100 in which a method for training a virtual image generating model or a method for generating a virtual image or an apparatus for training a virtual image generating model or an apparatus for generating a virtual image of embodiments of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, e.g., to acquire the virtual image generating model or the virtual image. The terminal devices 101, 102, and 103 may be provided with various communication client applications, such as a text processing application.

The terminal devices 101, 102, and 103 may be hardware, or may be software. When the terminal devices 101, 102, and 103 are hardware, the terminal devices may be various electronic devices, including but not limited to a smart phone, a tablet computer, a laptop portable computer, a desktop computer, and the like. When the terminal devices 101, 102, and 103 are software, the terminal devices may be installed in the above electronic devices, or may be implemented as a plurality of software programs or software modules, or may be implemented as a single software program or software module. This is not specifically limited here.

The server 105 may provide various services based on the determination of the virtual image generating model or the virtual image. For example, the server 105 may analyze and process a text acquired by the terminal devices 101, 102, and 103, and generate a processing result (e.g., determining a virtual image corresponding to the text).

It should be noted that the server 105 may be hardware, or may be software. When the server 105 is hardware, the server may be implemented as a distributed server cluster composed of a plurality of servers, or may be implemented as a single server. When the server 105 is software, the server may be implemented as a plurality of software programs or software modules (e.g., software programs or software modules for providing distributed services), or may be implemented as a single software program or software module. This is not specifically limited here.

It should be noted that the method for training a virtual image generating model or the method for generating a virtual image provided in embodiments of the present disclosure is generally executed by the server 105. Accordingly, the apparatus for training a virtual image generating model or the apparatus for generating a virtual image is generally provided in the server 105.

It should be understood that the numbers of terminal devices, networks, and servers in FIG. 1 are merely illustrative. Any number of terminal devices, networks, and servers may be provided based on actual requirements.

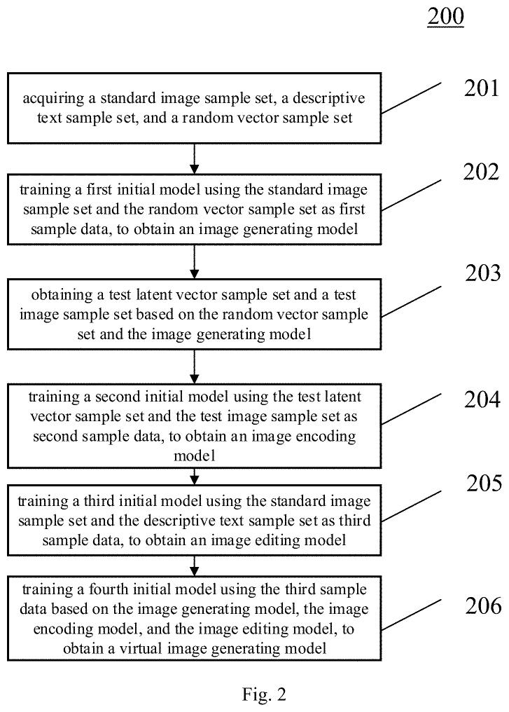

Further referring to FIG. 2, a process 200 of a method for training a virtual image generating model according to an embodiment of the present disclosure is shown. The method for training a virtual image generating model includes the following step 201 to step 206.

Step 201: acquiring a standard image sample set, a descriptive text sample set, and a random vector sample set.

In the present embodiment, an executing body (e.g., the server 105 shown in FIG. 1) of the method for training a virtual image generating model may acquire the standard image sample set, the descriptive text sample set, and the random vector sample set. An image in the standard image sample set may be an animal image, or may be a plant image, or may be a human face image, which is not limited in the present disclosure. A standard image may an image of an animal, or a plant, or a human face in a normal growth state and in a healthy state. For example, the standard image sample set is a sample set composed of human face images of a plurality of healthy Asians. The standard image sample set may be acquired from a public database, or the standard image sample set may be acquired by photographing a plurality of images. This is not limited in the present disclosure.

In the technical solutions of the present disclosure, the collection, storage, use, processing, transfer, provision, and disclosure of personal information of a user involved are in conformity with relevant laws and regulations, and do not violate public order and good customs.

A descriptive text in the descriptive text sample set is a text for describing features of a target virtual image. For example, contents of the descriptive text are long curly hair, big eyes, fair skin, and long eyelashes. A plurality of text passages describing features of the animal, or the plant, or the human face may be extracted from public texts to form the descriptive text sample set, or image features may be summarized and recorded literally based on a public animal image or plant image or human face image. A plurality of recorded text passages may be determined as the descriptive text sample set, or a public literal pool describing features of the animals, the plants, or the human faces may be acquired, a plurality of features may be selected arbitrarily from the literal pool to form a descriptive text, and a plurality of acquired descriptive texts may be determined as the descriptive text sample set. This is not limited in the present disclosure. A descriptive text in the descriptive text sample set may be an English text, or may be a Chinese text, or may be a text in other languages. This is not limited in the present disclosure.

A random vector in the random vector sample set is a random vector that is subjected to a uniform distribution or Gaussian distribution. A function generating a random vector that is subjected to the uniform distribution or Gaussian distribution may be created in advance, such that a plurality of random vectors are acquired based on the function to form the random vector sample set.

Step 202: training a first initial model using the standard image sample set and the random vector sample set as first sample data, to obtain an image generating model.

In the present embodiment, the executing body may, after acquiring the standard image sample set and the random vector sample set, train the first initial model using the standard image sample set and the random vector sample set as the first sample data, to obtain the image generating model. Specifically, the following training steps may be executed: inputting random vector samples in the random vector sample set into the first initial model to obtain an image corresponding to each random vector sample outputted from the first initial model; comparing each image outputted from the first initial model with a standard image in the standard image sample set, to obtain an accuracy rate of the first initial model; comparing the accuracy rate with a preset accuracy rate threshold, for example, the preset accuracy rate threshold being 80%; if the accuracy rate of the first initial model is greater than the preset accuracy rate threshold, determining the first initial model as the image generating model; and, if the accuracy rate of the first initial model is less than the preset accuracy rate threshold, adjust parameters of the first initial model to continue the training. The first initial model may be a style-based image generating model in a generative adversarial network. This is not limited in the present disclosure.

Step 203: obtaining a test latent vector sample set and a test image sample set based on the random vector sample set and the image generating model.

In the present embodiment, the executing body may obtain the test latent vector sample set and the test image sample set based on the random vector sample set and the image generating model. The image generating model may generate an intermediate variable as a latent vector with the random vector as an input, and finally output an image. Therefore, a plurality of random vector samples in the random vector sample set may be inputted into the image generating model to obtain a plurality of corresponding latent vectors and images, the obtained plurality of latent vectors may be determined as the test latent vector sample set, and the obtained plurality of images may be determined as the test image sample set. A latent vector is a vector that represents an image feature. By using the latent vector for representing the image feature, it is possible to decouple an association relationship between image features, and prevent a feature entanglement.

Step 204: training a second initial model using the test latent vector sample set and the test image sample set as second sample data, to obtain an image encoding model.

In the present embodiment, the executing body may, after obtaining the test latent vector sample set and the test image sample set, train the second initial model using the test latent vector sample set and the test image sample set as the second sample data, to obtain the image encoding model. Specifically, the following training steps may be executed: inputting test image samples in the test image sample set into the second initial model to obtain a latent vector corresponding to each test image sample outputted from the second initial model; comparing the latent vector outputted from the second initial model with a test latent vector in the test latent vector sample set, to obtain an accuracy rate of the second initial model; comparing the accuracy rate with a preset accuracy rate threshold, for example, the preset accuracy rate threshold being 80%; if the accuracy rate of the second initial model is greater than the preset accuracy rate threshold, determining the second initial model as the image encoding model; and, if the accuracy rate of the second initial model is less than the preset accuracy rate threshold, adjusting parameters of the second initial model to continue the training. The second initial model may be a style-based image encoding model in the generative adversarial network. This is not limited in the present disclosure.

Step 205: training a third initial model using the standard image sample set and the descriptive text sample set as third sample data, to obtain an image editing model.

In the present embodiment, the executing body may, after obtaining the standard image sample set and the descriptive text sample set, train the third initial model using the standard image sample set and the descriptive text sample set as the third sample data, to obtain the image editing model. Specifically, the following training steps may be executed: by using standard images in the standard image sample set as initial images, inputting the initial images and descriptive texts in the descriptive text sample set into the third initial model to obtain a deviation value between an initial image and a descriptive text outputted from the third initial model; editing each initial image based on the deviation value of the initial image outputted from the third initial model; comparing the edited image with the descriptive text to obtain a predicted accuracy rate of the third initial model; comparing the predicted accuracy rate with a preset accuracy rate threshold, for example, the preset accuracy rate threshold being 80%; if the predicted accuracy rate of the third initial model is greater than the preset accuracy rate threshold, determining the third initial model as the image editing model; and, if the accuracy rate of the third initial model is less than the preset accuracy rate threshold, adjusting parameters of the third initial model to continue the training. The third initial model may be a CLIP (Contrastive Language-Image Pre-training) model, which is not limited in the present disclosure, where the CLIP model is a model that can compute a difference between an image and a descriptive text.

Step 206: training a fourth initial model using the third sample data based on the image generating model, the image encoding model, and the image editing model, to obtain a virtual image generating model.

In the present embodiment, the executing body may, after obtaining the image generating model, the image encoding model, and the image editing model by training, train the fourth initial model using the third sample data based on the image generating model, the image encoding model, and the image editing model, to obtain the virtual image generating model. Specifically, the following training steps may be executed: converting the standard image sample set and the descriptive text sample set into a shape coefficient sample set and a latent vector sample set based on the image generating model, the image encoding model, and the image editing model; inputting a latent vector sample in the latent vector sample set into the fourth initial model to obtain a shape coefficient outputted from the fourth initial model; comparing the shape coefficient outputted from the fourth initial model with a shape coefficient sample, to obtain an accuracy rate of the fourth initial model; comparing the accuracy rate with a preset accuracy rate threshold, for example, the preset accuracy rate threshold being 80%; if the accuracy rate of the fourth initial model is greater than the preset accuracy rate threshold, determining the fourth initial model as the virtual image generating model; and, if the accuracy rate of the fourth initial model is less than the preset accuracy rate threshold, adjusting parameters of the fourth initial model to continue the training. The fourth initial model may be a model for generating a virtual image from a latent vector. This is not limited in the present disclosure.

The method for training a virtual image generating model provided in the embodiment of the present disclosure first trains an image generating model, an image encoding model, and an image editing model, and then obtains the virtual image generating model by training based on the image generating model, the image encoding model, and the image editing model, thereby, based on the above models, generating a virtual image directly from a text, improving the virtual image generation efficiency, and saving the costs.

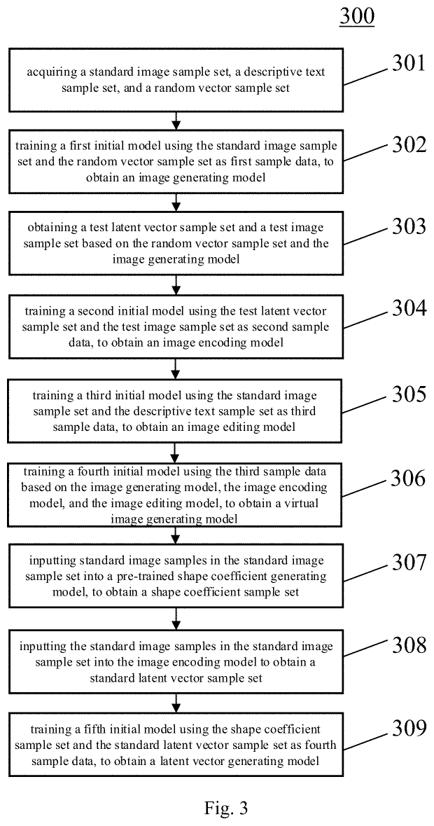

Further referring to FIG. 3, a process 300 of the method for training a virtual image generating model according to another embodiment of the present disclosure is shown. The method for training a virtual image generating model includes the following step 301 to step 309.

Step 301: acquiring a standard image sample set, a descriptive text sample set, and a random vector sample set.

Step 302: training a first initial model using the standard image sample set and the random vector sample set as first sample data, to obtain an image generating model.

Step 303: obtaining a test latent vector sample set and a test image sample set based on the random vector sample set and the image generating model.

Step 304: training a second initial model using the test latent vector sample set and the test image sample set as second sample data, to obtain an image encoding model.

Step 305: training a third initial model using the standard image sample set and the descriptive text sample set as third sample data, to obtain an image editing model.

Step 306: training a fourth initial model using the third sample data based on the image generating model, the image encoding model, and the image editing model, to obtain a virtual image generating model.

In the present embodiment, specific operations of steps 301 to 306 have been introduced in detail in steps 201 to 206 in the embodiment shown in FIG. 2. The description will not be repeated here.

Step 307: inputting standard image samples in the standard image sample set into a pre-trained shape coefficient generating model, to obtain a shape coefficient sample set.

In the present embodiment, the executing body may, after obtaining the standard image sample set, acquire the shape coefficient sample set based on the standard image sample set. Specifically, the standard image samples in the standard image sample set may be inputted as input data into the pre-trained shape coefficient generating model, to output a shape coefficient corresponding to each standard image sample from an output terminal of the shape coefficient generating model, and determine a plurality of outputted shape coefficients as the shape coefficient sample set. The pre-trained shape coefficient generating model may be a PTA (Photo-to-Avatar) model, which is a model that can, after receiving an image as input, output a plurality of corresponding shape coefficients by computing based on a model base of the image and a plurality of pre-stored relevant shape bases, where each of the plurality of shape coefficients represents a difference degree between the model base of the image and a respective pre-stored shape base.

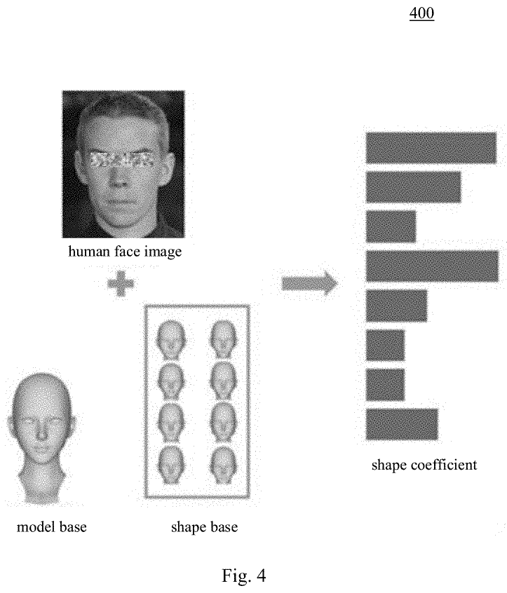

As shown in FIG. 4, a schematic diagram of generating a shape coefficient by a shape coefficient generating model according to the present disclosure is shown. As can be seen from FIG. 4, the shape coefficient generating model pre-stores a plurality of standard shape bases obtained based on a plurality of basic human face shapes, such as a thin and long face base, a round face base, and a square face base. A human face image is inputted as input data into the shape coefficient generating model, to obtain a shape coefficient of the inputted human face image corresponding to each standard shape base from the output terminal of the shape coefficient generating model by computing based on a model base of the inputted human face image and the plurality of standard shape bases, where each shape coefficient represents a difference degree between the model base of the inputted face image and a respective shape base.

Step 308: inputting the standard image samples in the standard image sample set into the image encoding model to obtain a standard latent vector sample set.

In the present embodiment, the executing body may, after obtaining the standard image sample set, acquire the standard latent vector sample set based on the standard image sample set. Specifically, the standard image samples in the standard image sample set may be inputted as input data into the image encoding model, to output a standard latent vector corresponding to each standard image sample from an output terminal of the image encoding model, and to determine a plurality of outputted standard latent vectors as the standard latent vector sample set. The image encoding model may be a style-based image encoding model in a generative adversarial network. The image encoding model is a model that can, after receiving an image as input, decode image features of the image, to output a latent vector corresponding to the inputted image. The standard latent vector is a vector that represents a standard image feature, and by using the standard latent vector for representing the image feature, it is possible to decouple an association relationship between image features, and preventing the feature entanglement.

Step 309: training a fifth initial model using the shape coefficient sample set and the standard latent vector sample set as fourth sample data, to obtain a latent vector generating model.

In the present embodiment, the executing body may, after obtaining the shape coefficient sample set and the standard latent vector sample set, train the fifth initial model using the shape coefficient sample set and the standard latent vector sample set as the fourth sample data, to obtain the latent vector generating model. Specifically, the following training steps may be executed: inputting shape coefficient samples in the shape coefficient sample set into the fifth initial model to obtain a latent vector corresponding to each shape coefficient sample outputted from the fifth initial model; comparing each latent vector outputted from the fifth initial model with a standard latent vector in the standard latent vector sample set, to obtain an accuracy rate of the fifth initial model; comparing the accuracy rate with a preset accuracy rate threshold, for example, the preset accuracy rate threshold being 80%; if the accuracy rate of the fifth initial model is greater than the preset accuracy rate threshold, determining the fifth initial model as the latent vector generating model; and, if the accuracy rate of the fifth initial model is less than the preset accuracy rate threshold, adjusting parameters of the fifth initial model to continue the training. The fifth initial model may be a model for generating a latent vector from a shape coefficient. This is not limited in the present disclosure.

As can be seen from FIG. 3, compared with the corresponding embodiment of FIG. 2, the method for training a virtual image generating model in the present embodiment obtains a latent vector generating model by training based on the shape coefficient sample set and the standard latent vector sample set, may further generate a latent vector based on the latent vector generating model, and further generates a virtual image using the latent vector, thereby improving the flexibility of generating the virtual image.

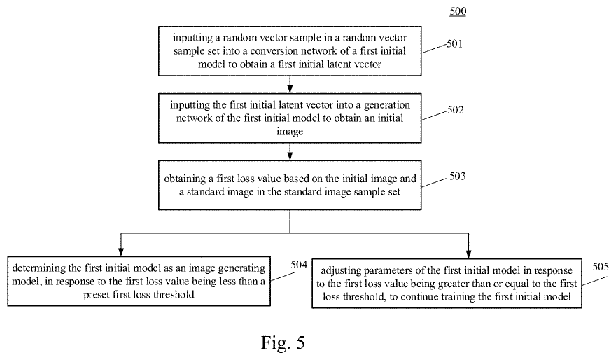

Further referring to FIG. 5, a process 500 of training a first initial model using a standard image sample set and a random vector sample set as first sample data, to obtain an image generating model according to an embodiment of the present disclosure is shown. The method for obtaining an image generating model includes the following step 501 to step 505.

Step 501: inputting a random vector sample in a random vector sample set into a conversion network of a first initial model to obtain a first initial latent vector.

In the present embodiment, the executing body may input a random vector sample in the random vector sample set into the conversion network of the first initial model to obtain a first initial latent vector. The conversion network is a network that converts a random vector into a latent vector in the first initial model. The random vector sample in the random vector sample set is inputted into the first initial model. The first initial model first converts the inputted random vector into the first initial latent vector using the conversion network, thereby decoupling an association relationship between features represented by the first initial latent vector, preventing the feature entanglement during the subsequent image generation, and improving the accuracy rate of the image generating model.

Step 502: inputting the first initial latent vector into a generation network of the first initial model to obtain an initial image.

In the present embodiment, the executing body may, after obtaining the first initial latent vector, input the first initial latent vector into the generation network of the first initial model to obtain the initial image. Specifically, the random vector sample in the random vector sample set is inputted into the first initial model. After obtaining the first initial latent vector using the conversion network, the first initial model may then use the first initial latent vector as input data into the generation network of the first initial model, to output a corresponding initial image from the generation network. The generation network is a network that converts a latent vector into an image in the first initial model, and the initial image generated by the generation network is the initial image generated by the first initial model.

Step 503: obtaining a first loss value based on the initial image and a standard image in the standard image sample set.

In the present embodiment, the executing body may, after obtaining the initial image, obtain the first loss value based on the initial image and the standard image in the standard image sample set. Specifically, data distribution of the initial image and data distribution of the standard image may be obtained, and a divergence distance between the data distribution of the initial image and the data distribution of the standard image may be determined as the first loss value.

After obtaining the first loss value, the executing body may compare the first loss value with a preset first loss threshold, execute step 504 if the first loss value is less than the preset first loss threshold, and execute step 505 if the first loss value is greater than or equal to the preset first loss threshold. For example, the preset first loss threshold is 0.05.

Step 504: determining the first initial model as an image generating model, in response to the first loss value being less than a preset first loss threshold.

In the present embodiment, the executing body may determine the first initial model as the image generating model, in response to the first loss value being less than the preset first loss threshold. Specifically, in response to the first loss value being less than the preset first loss threshold, the data distribution of the initial image outputted from the first initial model is consistent with the data distribution of the standard image. In this case, an output of the first initial model is desirable, the training of the first initial model is completed, and the first initial model is determined as the image generating model.

Step 505: adjusting parameters of the first initial model in response to the first loss value being greater than or equal to the first loss threshold, to continue training the first initial model.

In the present embodiment, the executing body may adjust the parameters of the first initial model in response to the first loss value being greater than or equal to the first loss threshold, to continue training the first initial model. Specifically, in response to the first loss value being greater than or equal to the first loss threshold, the data distribution of the initial image outputted from the first initial model is not subjected to the data distribution of the standard image. In this case, the output of the first initial model is undesirable, and the parameters of the first initial model may be adjusted by backpropagation based on the first loss value in the first initial model to continue training the first initial model.

As can be seen from FIG. 5, the method for obtaining an image generating model in the present embodiment can enable the obtained image generating model to generate a corresponding image subjected to a real data distribution based on the latent vector, thereby contributing to further obtaining a virtual image based on the image generating model, and improving the accuracy rate of the virtual image generating model.

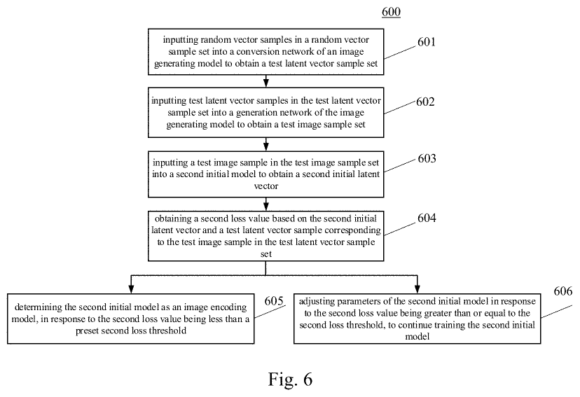

Further referring to FIG. 6, a process 600 of training a second initial model using a test latent vector sample set and a test image sample set as second sample data, to obtain an image encoding model according to an embodiment of the present disclosure is shown. The method for obtaining an image encoding model includes the following step 601 to step 606.

Step 601: inputting random vector samples in a random vector sample set into a conversion network of an image generating model to obtain a test latent vector sample set.

In the present embodiment, the executing body may input the random vector samples in the random vector sample set into the conversion network of the image generating model to obtain the test latent vector sample set. The image generating model may convert a random vector, which is used as an input, into a latent vector using the conversion network in the image generating model. The random vector samples in the random vector sample set are inputted into the image generating model. The image generating model first converts the inputted random vectors into respective test latent vectors using the conversion network, and determines a plurality of obtained test latent vectors as the test latent vector sample set.

Step 602: inputting test latent vector samples in the test latent vector sample set into a generation network of the image generating model to obtain a test image sample set.

In the present embodiment, the executing body may, after obtaining the test latent vector sample set, input the test latent vector samples in the test latent vector sample set into the generation network of the image generating model to obtain the test image sample set. Specifically, the random vector samples in the random vector sample set are inputted into the image generating model. After obtaining the test latent vector samples using the conversion network, the image generating model may then use the test latent vector samples as input data for inputting into the generation network of the image generating model, to output respective test image samples from the generation network, and determine a plurality of obtained test image samples as the test image sample set.

Step 603: inputting a test image sample in the test image sample set into a second initial model to obtain a second initial latent vector.

In the present embodiment, the executing body may, after obtaining the test image sample set, input a test image sample in the test image sample set into the second initial model to obtain the second initial latent vector. Specifically, the test image sample in the test image sample set may be inputted as input data into the second initial model to output a corresponding second initial latent vector from an output terminal of the second initial model.

Step 604: obtaining a second loss value based on the second initial latent vector and a test latent vector sample corresponding to the test image sample in the test latent vector sample set.

In the present embodiment, the executing body may, after obtaining the second initial latent vector, obtain the second loss value based on the second initial latent vector and a test latent vector sample corresponding to the test image sample in the test latent vector sample set. Specifically, the test latent vector sample, in the test latent vector sample set, corresponding to the test image sample inputted into the second initial model may be first acquired, and a loss value between the second initial latent vector and the test latent vector sample may be computed for use as the second loss value.

After obtaining the second loss value, the executing body may compare the second loss value with a preset second loss threshold, execute step 605 if the second loss value is less than the preset second loss threshold, and execute step 606 if the second loss value is greater than or equal to the preset second loss threshold. For example, the preset second loss threshold is 0.05.

Step 605: determining the second initial model as an image encoding model, in response to the second loss value being less than a preset second loss threshold.

In the present embodiment, the executing body may determine the second initial model as the image encoding model, in response to the second loss value being less than the preset second loss threshold. Specifically, in response to the second loss value being less than the preset second loss threshold, the second initial latent vector outputted from the second initial model is a correct latent vector corresponding to the test image sample. In this case, an output of the second initial model is desirable, the training of the second initial model is completed, and the second initial model is determined as the image encoding model.

Step 606: adjusting parameters of the second initial model in response to the second loss value being greater than or equal to the second loss threshold, to continue training the second initial model.

In the present embodiment, the executing body may adjust the parameters of the second initial model in response to the second loss value being greater than or equal to the second loss threshold, to continue training the second initial model. Specifically, in response to the second loss value being greater than or equal to the second loss threshold, the second initial latent vector outputted from the second initial model is not a correct latent vector corresponding to the test image sample. In this case, the output of the second initial model is undesirable, and the parameters of the second initial model may be adjusted by backpropagation based on the second loss value in the second initial model to continue training the second initial model.

As can be seen from FIG. 6, the method for obtaining an image encoding model in the present embodiment can enable the obtained image encoding model to generate a corresponding correct latent vector based on an image, thereby contributing to further obtaining a virtual image based on the image encoding model, and improving the accuracy rate of the virtual image generating model.

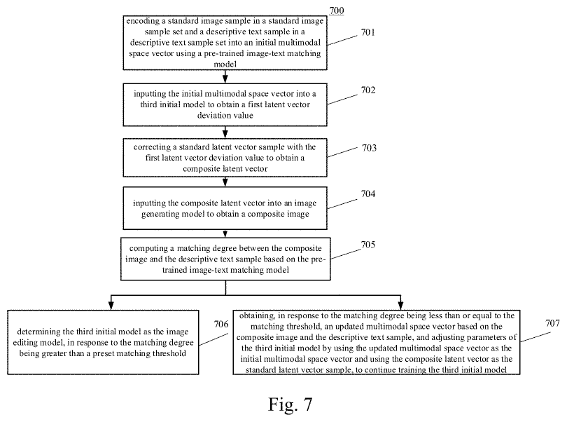

Further referring to FIG. 7, a process 700 of training a third initial model using a standard image sample set and a descriptive text sample set as third sample data, to obtain an image editing model according to an embodiment of the present disclosure is shown. The method for obtaining an image editing model includes the following step 701 to step 708.

Step 701: encoding a standard image sample in a standard image sample set and a descriptive text sample in a descriptive text sample set into an initial multimodal space vector using a pre-trained image-text matching model.

In the present embodiment, the executing body may encode the standard image sample in the standard image sample set and the descriptive text sample in the descriptive text sample set into the initial multimodal space vector using the pre-trained image-text matching model. The pre-trained image-text matching model may be an ERNIE-ViL (Enhanced Representation from kNowledge IntEgration) model, which is a multimodal characterization model based on scenario diagram analysis, combines visual and language information, may compute a matching value between an image and a paragraph of text, and may further encode an image and a paragraph of text into a multimodal space vector. Specifically, the standard image sample in the standard image sample set and the descriptive text sample in the descriptive text sample set may be inputted into the pre-trained image-text matching model, to encode the standard image sample and the descriptive text sample into the initial multimodal space vector based on the pre-trained image-text matching model, and output the initial multimodal space vector.

Step 702: inputting the initial multimodal space vector into a third initial model to obtain a first latent vector deviation value.

In the present embodiment, the executing body may, after obtaining the initial multimodal space vector, input the initial multimodal space vector into the third initial model to obtain the first latent vector deviation value. Specifically, the initial multimodal space vector may be used as input data for inputting into the third initial model, to output the first latent vector deviation value from an output terminal of the third initial model, where the first latent vector deviation value represents difference information between the standard image sample and the descriptive text sample.

Step 703: correcting a standard latent vector sample with the first latent vector deviation value to obtain a composite latent vector.

In the present embodiment, the executing body may, after obtaining the first latent vector deviation value, correct the standard latent vector sample with the first latent vector deviation value to obtain the composite latent vector. The first latent vector deviation value represents the difference information between the standard image sample and the descriptive text sample. Based on the difference information, the standard latent vector sample may be corrected to obtain a corrected standard latent vector sample combined with the difference information. The corrected standard latent vector sample is determined as the composite latent vector.

Step 704: inputting the composite latent vector into an image generating model to obtain a composite image.

In the present embodiment, the executing body may, after obtaining the composite latent vector, input the composite latent vector into the image generating model to obtain the composite image. Specifically, the composite latent vector may be used as input data for inputting into the image generating model, to output the corresponding composite image from an output terminal of the image generating model.

Step 705: computing a matching degree between the composite image and the descriptive text sample based on the pre-trained image-text matching model.

In the present embodiment, the executing body may, after obtaining the composite image, compute the matching degree between the composite image and the descriptive text sample based on the pre-trained image-text matching model. The pre-trained image-text matching model may compute a matching value between an image and a paragraph of text. Therefore, the composite image and the descriptive text sample may be used as input data for inputting into the pre-trained image-text matching model, to compute the matching degree between the composite image and the descriptive text sample based on the pre-trained image-text matching model, and output the computed matching degree from an output terminal of the pre-trained image-text matching model.

After obtaining the matching degree between the composite image and the descriptive text sample, the executing body may compare the matching degree with a preset matching threshold, execute step 706 if the matching degree is greater than the preset matching threshold, and execute step 707 if the matching degree is less than or equal to the matching threshold. For example, the preset matching threshold is 90%.

Step 706: determining the third initial model as the image editing model, in response to the matching degree being greater than a preset matching threshold.

In the present embodiment, the executing body may determine the third initial model as the image editing model, in response to the matching degree being greater than the preset matching threshold. Specifically, in response to the matching degree being greater than the preset matching threshold, the first latent vector deviation value outputted from the third initial model is a real difference between the image and the text of the initial multimodal space vector. In this case, an output of the third initial model is desirable, the training of the third initial model is completed, and the third initial model is determined as the image editing model.

Step 707: obtaining, in response to the matching degree being less than or equal to the matching threshold, an updated multimodal space vector based on the composite image and the descriptive text sample, and adjusting parameters of the third initial model by using the updated multimodal space vector as the initial multimodal space vector and using the composite latent vector as the standard latent vector sample, to continue training the third initial model.

In the present embodiment, the executing body may adjust the parameters of the third initial model in response to the matching degree being less than or equal to the matching threshold, to continue training the third initial model. Specifically, in response to the matching degree being less than or equal to the preset matching threshold, the first latent vector deviation value outputted from the third initial model is not a real difference between the image and the text of the initial multimodal space vector. In this case, the output of the third initial model is undesirable, the composite image and the descriptive text sample may be encoded into the updated multimodal space vector using the pre-trained image-text matching model, and the parameters of the third initial model may be adjusted by backpropagation based on the matching degree in the third initial model by using the updated multimodal space vector as the initial multimodal space vector and the composite latent vector as the standard latent vector sample to continue training the third initial model.

As can be seen from FIG. 7, the method for obtaining an image editing model in the present embodiment can enable the obtained image editing model to generate corresponding correct image-text difference information based on an inputted image and an inputted text, thereby contributing to further obtaining a virtual image based on the image editing model, and improving the accuracy rate of the virtual image generating model.

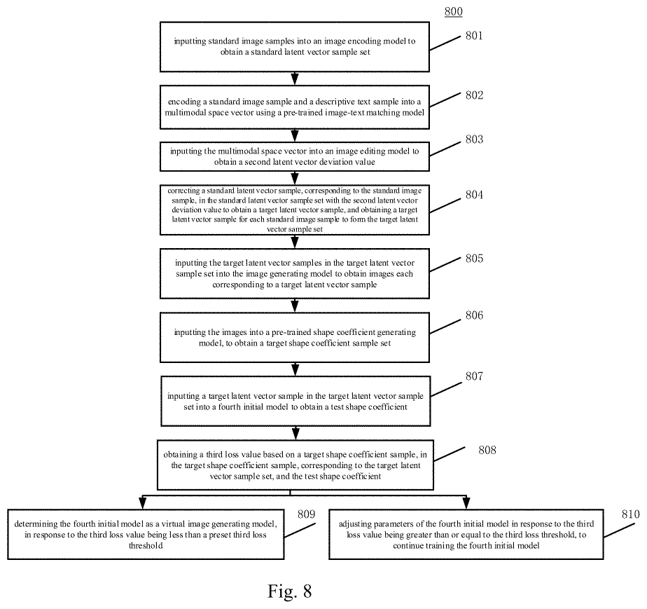

Further referring to FIG. 8, a process 800 of training a fourth initial model using the third sample data, to obtain a virtual image generating model according to an embodiment of the present disclosure is shown. The method for obtaining a virtual image generating model includes the following step 801 to step 809.

Step 801: inputting standard image samples into an image encoding model to obtain a standard latent vector sample set.

In the present embodiment, the executing body may input the standard image samples into the image encoding model to obtain the standard latent vector sample set. Specifically, each standard image sample in the standard image sample set may be used as input data for inputting into the image encoding model, to output a standard latent vector corresponding to the standard image sample from an output terminal of the image encoding model, and a plurality of outputted standard latent vectors are determined as the standard latent vector sample set. The standard latent vector is a vector that represents a standard image feature. By using the standard latent vector for representing the image feature, it is possible to decouple an association relationship between image features, and preventing the feature entanglement.

Step 802: encoding a standard image sample and a descriptive text sample into a multimodal space vector using a pre-trained image-text matching model.

In the present embodiment, the executing body may encode the standard image sample and the descriptive text sample into the multimodal space vector using the pre-trained image-text matching model. The pre-trained image-text matching model may be an ERNIE-ViL (Enhanced Representation from kNowledge IntEgration) model, which is a multimodal characterization model based on scenario diagram analysis, combines visual and language information, and may encode an image and a paragraph of text into a multimodal space vector. Specifically, the standard image sample and the descriptive text sample may be inputted into the pre-trained image-text matching model, to encode the standard image sample and the descriptive text sample into the multimodal space vector based on the pre-trained image-text matching model, and output the multimodal space vector.

Step 803: inputting the multimodal space vector into an image editing model to obtain a second latent vector deviation value.

In the present embodiment, the executing body may, after obtaining the multimodal space vector, input the multimodal space vector into the image editing model to obtain the second latent vector deviation value. Specifically, the multimodal space vector may be used as input data for inputting into the image editing model, to output the second latent vector deviation value from an output terminal of the image editing model, where the second latent vector deviation value represents difference information between the standard image sample and the descriptive text sample.

Step 804: correcting a standard latent vector sample, corresponding to the standard image sample, in the standard latent vector sample set with the second latent vector deviation value to obtain a target latent vector sample, and obtaining a target latent vector sample for each standard image sample to form the target latent vector sample set.

In the present embodiment, the executing body may, after obtaining the second latent vector deviation value, correcting a standard latent vector sample, corresponding to the standard image sample, in the standard latent vector sample set with the second latent vector deviation value to obtain a target latent vector sample, and obtain a target latent vector sample for each standard image sample to form the target latent vector sample set. The second latent vector deviation value represents the difference information between the standard image sample and the descriptive text sample. The standard latent vector sample corresponding to the standard image sample in the standard latent vector sample set may be first found, the standard latent vector sample may be corrected based on the difference information to obtain a corrected standard latent vector sample combined with the difference information, and the corrected standard latent vector sample is determined as a target latent vector. A plurality of obtained target latent vectors corresponding to the standard latent vector samples are determined as the target latent vector sample set.

Step 805: inputting the target latent vector samples in the target latent vector sample set into the image generating model to obtain images each corresponding to a target latent vector sample.

In the present embodiment, the executing body may, after obtaining the target latent vector sample set, input the target latent vector samples in the target latent vector sample set into the image generating model to obtain the images, each of which corresponds to the latent vector sample. Specifically, the target latent vector sample in the target latent vector sample set may be used as input data for inputting into the image generating model, to output the image corresponding to the target latent vector sample from an output terminal of the image generating model.

Step 806: inputting the images into a pre-trained shape coefficient generating model, to obtain a target shape coefficient sample set.

In the present embodiment, the executing body may, after obtaining the images corresponding to respective target latent vector samples, input the images into the pre-trained shape coefficient generating model, to obtain the target shape coefficient sample set. Specifically, the image corresponding to the target latent vector sample may be used as input data for inputting into the pre-trained shape coefficient generating model, to output a shape coefficient corresponding to the image from an output terminal of the shape coefficient generating model, and a plurality of outputted shape coefficients are determined as the shape coefficient sample set. The pre-trained shape coefficient generating model may be a PTA (Photo-to-Avatar) model, which is a model that can, after receiving an image as an input, output a plurality of corresponding shape coefficients by computing based on a model base of the image and a plurality of pre-stored relevant shape bases, where each of the plurality of shape coefficients represents a difference degree between the model base of the image and each pre-stored shape base.

Set 807: inputting a target latent vector sample in the target latent vector sample set into a fourth initial model to obtain a test shape coefficient.

In the present embodiment, the executing body may input the target latent vector sample in the target latent vector sample set into the fourth initial model to obtain the test shape coefficient. Specifically, the target latent vector sample in the target latent vector sample set may be used as input data for inputting into the fourth initial model, to output the test shape coefficient corresponding to the target latent vector sample from an output terminal of the fourth initial model.

Step 808: obtaining a third loss value based on a target shape coefficient sample, in the target shape coefficient sample, corresponding to the target latent vector sample set, and the test shape coefficient.

In the present embodiment, the executing body may, after obtaining the test shape coefficient, obtain the third loss value based on a target shape coefficient sample, in the target shape coefficient sample, corresponding to the target latent vector sample set, and the test shape coefficient. Specifically, the target shape coefficient sample, in the target shape coefficient sample set, corresponding to the target latent vector sample may be first acquired, and a mean square error between the target shape coefficient sample and the test shape coefficient may be computed for use as the third loss value.

After obtaining the third loss value, the executing body may compare the third loss value with a preset third loss threshold, execute step 809 if the third loss value is less than the preset third loss threshold, and execute step 810 if the third loss value is greater than or equal to the preset third loss threshold. For example, the preset third loss threshold is 0.05.

Step 809: determining the fourth initial model as a virtual image generating model, in response to the third loss value being less than a preset third loss threshold.

In the present embodiment, the executing body may determine the fourth initial model as the virtual image generating model, in response to the third loss value being less than the preset third loss threshold. Specifically, in response to the third loss value being less than the preset third loss threshold, the test shape coefficient outputted from the fourth initial model is a correct shape coefficient corresponding to the target latent vector sample. In this case, an output of the fourth initial model is desirable, the training of the fourth initial model is completed, and the fourth initial model is determined as the virtual image generating model.

Step 810: adjusting parameters of the fourth initial model in response to the third loss value being greater than or equal to the third loss threshold, to continue training the fourth initial model.

In the present embodiment, the executing body may adjust the parameters of the fourth initial model in response to the third loss value being greater than or equal to the third loss threshold, to continue training the fourth initial model. Specifically, in response to the third loss value being greater than or equal to the third loss threshold, the test shape coefficient outputted from the fourth initial model is not a correct shape coefficient corresponding to the target latent vector sample. In this case, the output of the fourth initial model is undesirable, and the parameters of the fourth initial model may be adjusted by backpropagation based on the third loss value in the fourth initial model to continue training the fourth initial model.

As can be seen from FIG. 8, the method for determining a virtual image generating model in the present embodiment can enable the obtained virtual image generating model to generate a corresponding correct shape coefficient based on an inputted latent vector, thereby contributing to obtaining a virtual image based on the shape coefficient, and improving the efficiency, flexibility, and diversity of the virtual image generating model.

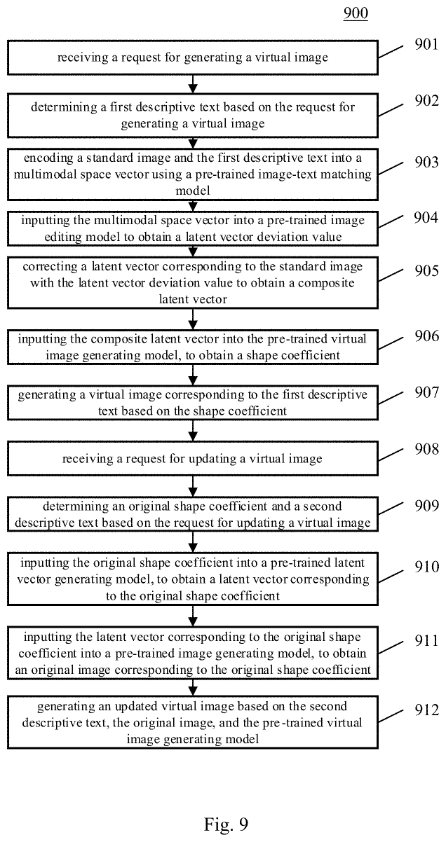

Further referring to FIG. 9, a process 900 of a method for generating a virtual image according to an embodiment of the present disclosure is shown. The method for generating a virtual image includes the following step 901 to step 912.

Step 901: receiving a request for generating a virtual image.

In the present embodiment, the executing body may receive the request for generating a virtual image. The request for generating a virtual image may be in a voice form, or may be in a text form. This is not limited in the present disclosure. The request for generating a virtual image is a request that requests for generating a target virtual image. For example, the request for generating a virtual image is a text, a content of which is to generate a virtual image with yellow skin, big eyes, and yellow curly hair, and wearing a suit. When the request for generating a virtual image is detected, the request for generating a virtual image may be transmitted to a receiving function.

Step 902: determining a first descriptive text based on the request for generating a virtual image.

In the present embodiment, the executing body may, after receiving the request for generating a virtual image, determine the first descriptive text based on the request for generating a virtual image. Specifically, in response to the request for generating a virtual image being in a voice form, the request for generating a virtual image is first converted from voice into a text, and then a content describing the virtual image is acquired from the text, and is determined as the first descriptive text. In response to the request for generating a virtual image being in a text form, a content describing the virtual image is acquired from the request for generating a virtual image, and is determined as the first descriptive text.

Step 903: encoding a standard image and the first descriptive text into a multimodal space vector using a pre-trained image-text matching model.

In the present embodiment, the standard image may be any image taken from a standard image sample set, or the standard image may be an average image obtained by averaging all images in the standard image sample set. The standard image is not limited in the present disclosure.

In the present embodiment, the executing body may encode the standard image and the first descriptive text into the multimodal space vector using the pre-trained image-text matching model. The pre-trained image-text matching model may be an ERNIE-ViL (Enhanced Representation from kNowledge IntEgration) model, which is a multimodal characterization model based on scenario diagram analysis, combines visual and language information, and may encode an image and a paragraph of text into a multimodal space vector. Specifically, the standard image and the first descriptive text may be inputted into the pre-trained image-text matching model, to encode the standard image and the first descriptive text into the multimodal space vector based on the pre-trained image-text matching model, and output the multimodal space vector.

Step 904: inputting the multimodal space vector into a pre-trained image editing model to obtain a latent vector deviation value.

In the present embodiment, the executing body may, after obtaining the multimodal space vector, input the multimodal space vector into the pre-trained image editing model to obtain the latent vector deviation value. Specifically, the multimodal space vector may be used as input data for inputting into the pre-trained image editing model, to output the latent vector deviation value from an output terminal of the image editing model, where the latent vector deviation value represents difference information between the standard image and the first descriptive text.

Step 905: correcting a latent vector corresponding to the standard image with the latent vector deviation value to obtain a composite latent vector.

In the present embodiment, the executing body may, after obtaining the latent vector deviation value, correct the latent vector corresponding to the standard image with the latent vector deviation value to obtain the composite latent vector. The latent vector deviation value represents the difference information between the standard image and the first descriptive text. The standard image may be first inputted into the pre-trained image encoding model to obtain the latent vector corresponding to the standard image, and the obtained latent vector may be corrected based on the difference information, to obtain a corrected latent vector combined with the difference information. The corrected latent vector is determined as the composite latent vector.

Step 906: inputting the composite latent vector into the pre-trained virtual image generating model, to obtain a shape coefficient.

In the present embodiment, the executing body may, after obtaining the composite latent vector, input the composite latent vector into the pre-trained virtual image generating model, to obtain the shape coefficient. Specifically, the composite latent vector may be used as input data for inputting into the pre-trained virtual image generating model, to output the shape coefficient corresponding to the composite latent vector from an output terminal of the virtual image generating model. The pre-trained virtual image generating model is obtained by the training methods shown in FIG. 2 to FIG. 8.

Step 907: generating a virtual image corresponding to the first descriptive text based on the shape coefficient.

In the present embodiment, the executing body may, after obtaining the shape coefficient, generate the virtual image corresponding to the first descriptive text based on the shape coefficient. Specifically, a plurality of standard shape bases may be pre-acquired. For example, if the virtual image corresponding to the first descriptive text is a human-shaped virtual image, a plurality of standard shape bases may be pre-obtained based on a plurality of basic human face shapes, such as a thin and long face base, a round face base, and a square face base, the composite latent vector may be inputted into a pre-trained image generating model to obtain a composite image corresponding to the composite latent vector, a basic model base may be obtained based on the composite image, and the virtual image corresponding to the first descriptive text may be computed based on the basic model base, the plurality of standard shape bases, and the obtained shape coefficient in accordance with the following equation:

$${Vertex}_{i} = {VertexBase}_{i} + {\sum }_{j = 0}^{m} {β}_{j} ( {VertexBS}_{( j , i )} - {VertexBase}_{i} )$$

where i is a vertex number of the model, Vertexᵢ represents composite coordinates of the i-th vertex of the virtual image, VertexBaseᵢ represents coordinates of the i-th vertex of the basic model base, m is the number of standard shape bases, j is a standard shape base number, VertexBS_{(j,i)} represents coordinates of the i-th vertex of the j-th standard shape base, and βⱼ represents a shape coefficient corresponding to the j-th standard shape base.

Step 908: receiving a request for updating a virtual image.

In the present embodiment, the executing body may receive the request for updating a virtual image. The request for updating a virtual image may be in a voice form, or may be in a text form. This is not limited in the present disclosure. The request for updating a virtual image is a request that requests for updating a generated target virtual image. For example, the request for updating a virtual image is a text, a content of which is to update yellow curly hair of an existing virtual image to a virtual image with black long straight hair. When the request for updating a virtual image is detected, the request for updating a virtual image may be transmitted to an updating function.

Step 909: determining an original shape coefficient and a second descriptive text based on the request for updating a virtual image.

In the present embodiment, the executing body may, after receiving the request for updating a virtual image, determine the original shape coefficient and the second descriptive text based on the request for updating a virtual image. Specifically, in response to the request for updating a virtual image being in a voice form, the request for updating a virtual image is first converted from the voice into a text, then a content describing the virtual image is acquired from the text, and is determined as the second descriptive text, and the original shape coefficient is acquired from the text. In response to the request for updating a virtual image being in a text form, a content describing the virtual image is acquired from the request for updating a virtual image, and is determined as the second descriptive text, and the original shape coefficient is acquired from the text. For example, the original shape coefficient is a shape coefficient of the virtual image corresponding to the first descriptive text.

Step 910: inputting the original shape coefficient into a pre-trained latent vector generating model, to obtain a latent vector corresponding to the original shape coefficient.

In the present embodiment, the executing body may, after acquiring the original shape coefficient, input the original shape coefficient into the pre-trained latent vector generating model, to obtain the latent vector corresponding to the original shape coefficient. Specifically, the original shape coefficient may be used as input data for inputting into the pre-trained latent vector generating model, to output the latent vector corresponding to the original shape coefficient from an output terminal of the latent vector generating model.

Step 911: inputting the latent vector corresponding to the original shape coefficient into a pre-trained image generating model, to obtain an original image corresponding to the original shape coefficient.

In the present embodiment, the executing body may, after acquiring the latent vector corresponding to the original shape coefficient, input the latent vector corresponding to the original shape coefficient into the pre-trained image generating model, to obtain the original image corresponding to the original shape coefficient. Specifically, the latent vector corresponding to the original shape coefficient may be used as input data for inputting into the pre-trained image generating model, to output the original image corresponding to the original shape coefficient from an output terminal of the image generating model.

Step 912: generating an updated virtual image based on the second descriptive text, the original image, and the pre-trained virtual image generating model.

In the present embodiment, the executing body may generate the updated virtual image based on the second descriptive text, the original image, and the pre-trained virtual image generating model. Specifically, an updated latent vector may be first obtained based on the second descriptive text and the original image, the updated latent vector may be inputted into the pre-trained virtual image generating model to obtain a shape coefficient corresponding to the updated latent vector, the updated latent vector may be inputted into the pre-trained image generating model to obtain an updated image corresponding to the updated latent vector, a basic model base may be obtained based on the updated image, and a plurality of standard shape bases may be pre-acquired. For example, if a virtual image corresponding to the second descriptive text is a human-shaped virtual image, a plurality of standard shape bases may be pre-obtained based on a plurality of basic human face shapes, such as a thin and long face base, a round face base, and a square face base, and an updated virtual image corresponding to the second descriptive text may be computed based on the basic model base, the plurality of standard shape bases, and the obtained shape coefficient in accordance with the following equation:

$${Vertex}_{i} = {VertexBase}_{i} + {\sum }_{j = 0}^{m} {β}_{j} ( {VertexBS}_{( j , i )} - {VertexBase}_{i} )$$

where i is a vertex number of the model, Vertexᵢ represents composite coordinates of the i-th vertex of the updated virtual image, VertexBaseᵢ represents coordinates of the i-th vertex of the basic model base, m is the number of standard shape bases, j is a standard shape base number, VertexBS_{(j,i)} represents coordinates of the i-th vertex of the j-th standard shape base, and βⱼ represents a shape coefficient corresponding to the j-th standard shape base.

As can be seen from FIG. 9, the method for generating a virtual image in the present embodiment may generate a virtual image directly from a text, thereby improving the virtual image generation efficiency, the diversity and accuracy of the generated virtual image, saving the costs, and improving the user experience.

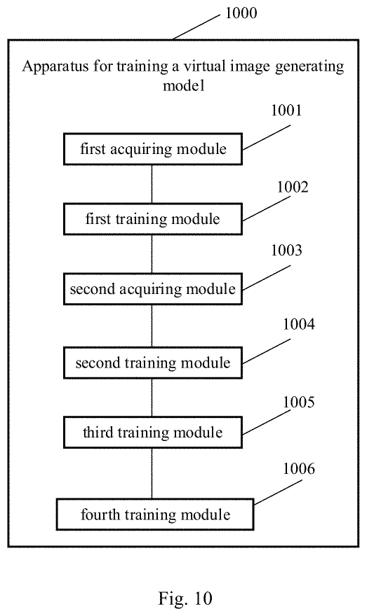

Further referring to FIG. 10, as an implementation of the above method for training a virtual image generating model, an embodiment of the present disclosure provides an apparatus for training a virtual image generating model. The embodiment of the apparatus corresponds to the embodiment of the method shown in FIG. 2, and the apparatus may be specifically applied to various electronic devices.

As shown in FIG. 10, the apparatus 1000 for training a virtual image generating model of the present embodiment may include: a first acquiring module 1001, a first training module 1002, a second acquiring module 1003, a second training module 1004, a third training module 1005, and a fourth training module 1006. The first acquiring module 1001 is configured to acquire a standard image sample set, a descriptive text sample set, and a random vector sample set; the first training module 1002 is configured to train a first initial model using the standard image sample set and the random vector sample set as first sample data, to obtain an image generating model; the second acquiring module 1003 is configured to obtain a test latent vector sample set and a test image sample set based on the random vector sample set and the image generating model; the second training module 1004 is configured to train a second initial model using the test latent vector sample set and the test image sample set as second sample data, to obtain an image encoding model; the third training module 1005 is configured to train a third initial model using the standard image sample set and the descriptive text sample set as third sample data, to obtain an image editing model; and the fourth training module 1006 is configured to train a fourth initial model using the third sample data based on the image generating model, the image encoding model, and the image editing model, to obtain the virtual image generating model.

The related description of steps 201 to 206 in the corresponding embodiment of FIG. 2 may be referred to for specific processing of the first acquiring module 1001, the first training module 1002, the second acquiring module 1003, the second training module 1004, the third training module 1005, and the fourth training module 1006 of the apparatus 1000 for training a virtual image generating model in the present embodiment and the technical effects thereof, respectively. The description will not be repeated here.

In some alternative implementations of the present embodiment, the apparatus 1000 for training a virtual image generating model further includes: a third acquiring module configured to input standard image samples in the standard image sample set into a pre-trained shape coefficient generating model, to obtain a shape coefficient sample set; a fourth acquiring module configured to input the standard image samples in the standard image sample set into the image encoding model to obtain a standard latent vector sample set; and a fifth training module configured to train a fifth initial model using the shape coefficient sample set and the standard latent vector sample set as fourth sample data, to obtain a latent vector generating model.

In some alternative implementations of the present embodiment, the first training module 1002 includes: a first acquiring submodule configured to input a random vector sample in the random vector sample set into a conversion network of the first initial model to obtain a first initial latent vector; a second acquiring submodule configured to input the first initial latent vector into a generation network of the first initial model to obtain an initial image; a third acquiring submodule configured to obtain a first loss value based on the initial image and a standard image in the standard image sample set; a first determining submodule configured to determine the first initial model as the image generating model, in response to the first loss value being less than a preset first loss threshold; and a second determining submodule configured to adjust parameters of the first initial model in response to the first loss value being greater than or equal to the first loss threshold, to continue training the first initial model.

In some alternative implementations of the present embodiment, the second acquiring module 1003 includes: a fourth acquiring submodule configured to input the random vector samples in the random vector sample set into a conversion network of the image generating model to obtain the test latent vector sample set; and a fifth acquiring submodule configured to input test latent vector samples in the test latent vector sample set into a generation network of the image generating model to obtain the test image sample set.

In some alternative implementations of the present embodiment, the second training module 1004 includes: a sixth acquiring submodule configured to input a test image sample in the test image sample set into the second initial model to obtain a second initial latent vector; a seventh acquiring submodule configured to obtain a second loss value based on the second initial latent vector and a test latent vector sample, corresponding to the test image sample, in the test latent vector sample set; a third determining submodule configured to determine the second initial model as the image encoding model, in response to the second loss value being less than a second loss threshold that is pre-set; and a fourth determining submodule configured to adjust parameters of the second initial model in response to the second loss value being greater than or equal to the second loss threshold, to continue training the second initial model.

In some alternative implementations of the present embodiment, the third training module 1005 includes: a first encoding submodule configured to encode a standard image sample in the standard image sample set and a descriptive text sample in the descriptive text sample set into an initial multimodal space vector using a pre-trained image-text matching model; an eighth acquiring submodule configured to input the initial multimodal space vector into the third initial model, to obtain a composite image and a composite latent vector based on the image generating model and a standard latent vector sample in the standard latent vector sample set; a computing submodule configured to compute a matching degree between the composite image and the descriptive text sample based on the pre-trained image-text matching model; a fifth determining submodule configured to determine the third initial model as the image editing model, in response to the matching degree being greater than a matching threshold that is pre-set; and a sixth determining submodule configured to obtain, in response to the matching degree being less than or equal to the matching threshold, an updated multimodal space vector based on the composite image and the descriptive text sample, and adjusting parameters of the third initial model by using the updated multimodal space vector as the initial multimodal space vector and using the composite latent vector as the standard latent vector sample, to continue training the third initial model.

In some alternative implementations of the present embodiment, the eighth acquiring submodule includes: a first acquiring unit configured to input the initial multimodal space vector into the third initial model to obtain a first latent vector deviation value; a second acquiring unit configured to correct the standard latent vector sample with the first latent vector deviation value to obtain the composite latent vector; and a third acquiring unit configured to input the composite latent vector into the image generating model to obtain the composite image.

In some alternative implementations of the present embodiment, the fourth training module 1006 includes: a ninth acquiring submodule configured to obtain a target shape coefficient sample set and a target latent vector sample set by using standard image samples in the standard image sample set and descriptive text samples in the descriptive text sample set as input data, based on the image generating model, the image encoding model, and the image editing model; a tenth acquiring submodule configured to input a target latent vector sample in the target latent vector sample set into the fourth initial model to obtain a test shape coefficient; an eleventh acquiring submodule configured to obtain a third loss value based on a target shape coefficient sample, corresponding to the target latent vector sample, in the target shape coefficient sample set and the test shape coefficient; a seventh determining submodule configured to determine the fourth initial model as the virtual image generating model, in response to the third loss value being less than a third loss threshold that is pre-set; and an eighth determining submodule configured to adjust parameters of the fourth initial model in response to the third loss value being greater than or equal to the third loss threshold, to continue training the fourth initial model.

In some alternative implementations of the present embodiment, the ninth acquiring submodule includes: a fourth acquiring unit configured to input the standard image samples into the image encoding model to obtain a standard latent vector sample set; an encoding unit configured to encode a standard image sample and a descriptive text sample into a multimodal space vector using a pre-trained image-text matching model; a fifth acquiring unit configured to input the multimodal space vector into the image editing model to obtain a second latent vector deviation value; a sixth acquiring unit configured to correct a standard latent vector sample, corresponding to the standard image sample, in the standard latent vector sample set with the second latent vector deviation value to obtain a target latent vector sample, and obtain a target latent vector sample for each standard image sample to form the target latent vector sample set; a seventh acquiring unit configured to input the target latent vector samples in the target latent vector sample set into the image generating model to obtain images each corresponding to a target latent vector sample; and an eighth acquiring unit configured to input the images into a pre-trained shape coefficient generating model, to obtain the target shape coefficient sample set.

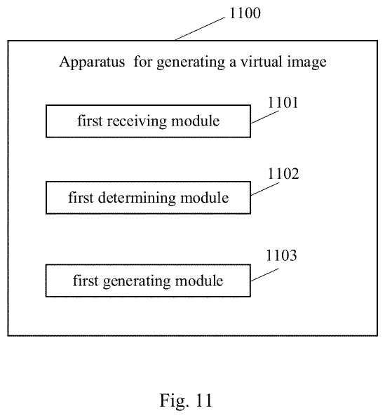

Further referring to FIG. 11, as an implementation of the above method for generating a virtual image, an embodiment of the present disclosure provides an apparatus for generating a virtual image. The embodiment of the apparatus corresponds to the embodiment of the method shown in FIG. 9, and the apparatus may be specifically applied to various electronic devices.

As shown in FIG. 11, the apparatus 1100 for generating a virtual image of the present embodiment may include: a first receiving module 1101, a first determining module 1102, and a first generating module 1103. The first receiving module 1101 is configured to receive a request for generating a virtual image; the first determining module 1102 is configured to determine a first descriptive text based on the request for generating a virtual image; and the first generating module 1103 is configured to generate a virtual image corresponding to the first descriptive text based on the first descriptive text, a standard image that is pre-set, and a pre-trained virtual image generating model.

The related description of steps 901 to 907 in the corresponding embodiment of FIG. 9 may be referred to for specific processing of the first receiving module 1101, the first determining module 1102, and the first generating module 1103 of the apparatus 1100 for generating a virtual image in the present embodiment and the technical effects thereof, respectively. The description will not be repeated here.

In some alternative implementations of the present embodiment, the first generating module 1103 includes: a second encoding submodule configured to encode the standard image and the first descriptive text into a multimodal space vector using a pre-trained image-text matching model; a twelfth acquiring submodule configured to input the multimodal space vector into a pre-trained image editing model to obtain a latent vector deviation value; a thirteenth acquiring submodule configured to correct a latent vector corresponding to the standard image with the latent vector deviation value to obtain a composite latent vector; a fourteenth acquiring submodule configured to input the composite latent vector into the pre-trained virtual image generating model, to obtain a shape coefficient; and a generating submodule configured to generate the virtual image corresponding to the first descriptive text based on the shape coefficient.

In some alternative implementations of the present embodiment, the apparatus 1100 for generating a virtual image further includes: a second receiving module configured to receive a request for updating a virtual image; a second determining module configured to determine an original shape coefficient and a second descriptive text based on the request for updating a virtual image; a fifth acquiring module configured to input the original shape coefficient into a pre-trained latent vector generating model, to obtain a latent vector corresponding to the original shape coefficient; a sixth acquiring module configured to input the latent vector corresponding to the original shape coefficient into a pre-trained image generating model, to obtain an original image corresponding to the original shape coefficient; and a second generating module configured to generate an updated virtual image based on the second descriptive text, the original image, and the pre-trained virtual image generating model.

According to an embodiment of the present disclosure, the present disclosure further provides an electronic device, a readable storage medium, and a computer program product.

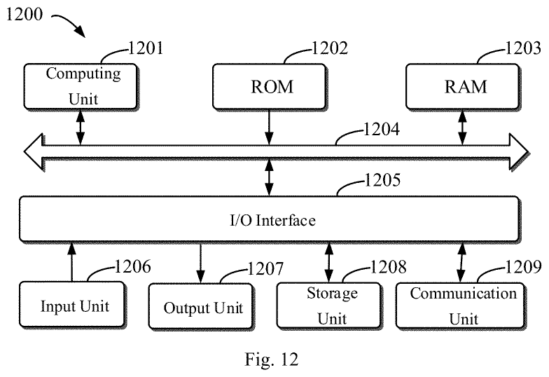

FIG. 12 shows a schematic block diagram of an example electronic device 1200 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may further represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 12, the device 1200 includes a computing unit 1201, which may execute various appropriate actions and processes in accordance with a computer program stored in a read-only memory (ROM) 1202 or a computer program loaded into a random-access memory (RAM) 1203 from a storage unit 1208. The RAM 1203 may further store various programs and data required by operations of the device 1200. The computing unit 1201, the ROM 1202, and the RAM 1203 are connected to each other through a bus 1204. An input/output (I/O) interface 1205 is also connected to the bus 1204.

A plurality of components in the device 1200 is connected to the I/O interface 1205, including: an input unit 1206, such as a keyboard and a mouse; an output unit 1207, such as various types of displays and speakers; a storage unit 1208, such as a magnetic disk and an optical disk; and a communication unit 1209, such as a network card, a modem, and a wireless communication transceiver. The communication unit 1209 allows the device 1200 to exchange information/data with other devices via a computer network such as the Internet and/or various telecommunication networks.

The computing unit 1201 may be various general-purpose and/or special-purpose processing components having a processing power and a computing power. Some examples of the computing unit 1201 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. The computing unit 1201 executes various methods and processes described above, such as a method for training a virtual image generating model or a method for generating a virtual image. For example, in some embodiments, the method for training a virtual image generating model or the method for generating a virtual image may be implemented as a computer software program that is tangibly included in a machine-readable medium, such as the storage unit 1208. In some embodiments, some or all of the computer programs may be loaded and/or installed onto the device 1200 via the ROM 1202 and/or the communication unit 1209. When the computer program is loaded into the RAM 1203 and executed by the computing unit 1201, one or more steps of the method for training a virtual image generating model or the method for generating a virtual image described above may be executed. Alternatively, in other embodiments, the computing unit 1201 may be configured to execute the method for training a virtual image generating model or the method for generating a virtual image by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output apparatus.

Program codes for implementing the method of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a distributed system server, or a server combined with a blockchain. The server may also be a cloud server, or an intelligent cloud computing server or intelligent cloud host with an artificial intelligence technology. The server may be a distributed system server, or a server combined with a blockchain. The server may also be a cloud server, or an intelligent cloud computing server or intelligent cloud host with an artificial intelligence technology.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for training a virtual image generating model, comprising:
acquiring a standard image sample set, a descriptive text sample set, and a random vector sample set;
training a first initial model using the standard image sample set and the random vector sample set as first sample data, to obtain an image generating model;
obtaining a test latent vector sample set and a test image sample set based on the random vector sample set and the image generating model;
training a second initial model using the test latent vector sample set and the test image sample set as second sample data, to obtain an image encoding model;
training a third initial model using the standard image sample set and the descriptive text sample set as third sample data, to obtain an image editing model; and
training a fourth initial model using the third sample data based on the image generating model, the image encoding model, and the image editing model, to obtain the virtual image generating model.

2. The method according to claim 1, wherein the method further comprises:
inputting standard image samples in the standard image sample set into a pre-trained shape coefficient generating model, to obtain a shape coefficient sample set;
inputting the standard image samples in the standard image sample set into the image encoding model to obtain a standard latent vector sample set; and
training a fifth initial model using the shape coefficient sample set and the standard latent vector sample set as fourth sample data, to obtain a latent vector generating model.

3. The method according to claim 1, wherein training the first initial model using the standard image sample set and the random vector sample set as the first sample data, to obtain the image generating model comprises:
inputting a random vector sample in the random vector sample set into a conversion network of the first initial model to obtain a first initial latent vector;
inputting the first initial latent vector into a generation network of the first initial model to obtain an initial image;
obtaining a first loss value based on the initial image and a standard image in the standard image sample set;
determining the first initial model as the image generating model, in response to the first loss value being less than a preset first loss threshold; and
adjusting parameters of the first initial model in response to the first loss value being greater than or equal to the first loss threshold, to continue training the first initial model.

4. The method according to claim 3, wherein obtaining the test latent vector sample set and the test image sample set based on the random vector sample set and the image generating model comprises:
inputting the random vector samples in the random vector sample set into a conversion network of the image generating model to obtain the test latent vector sample set; and
inputting test latent vector samples in the test latent vector sample set into a generation network of the image generating model to obtain the test image sample set.

5. The method according to claim 4, wherein training the second initial model using the test latent vector sample set and the test image sample set as the second sample data, to obtain the image encoding model comprises:
inputting a test image sample in the test image sample set into the second initial model to obtain a second initial latent vector;
obtaining a second loss value based on the second initial latent vector and a test latent vector sample, corresponding to the test image sample, in the test latent vector sample set;
determining the second initial model as the image encoding model, in response to the second loss value being less than a second loss threshold that is pre-set; and
adjusting parameters of the second initial model in response to the second loss value being greater than or equal to the second loss threshold, to continue training the second initial model.

6. The method according to claim 2, wherein training the third initial model using the standard image sample set and the descriptive text sample set as the third sample data, to obtain the image editing model comprises:
encoding a standard image sample in the standard image sample set and a descriptive text sample in the descriptive text sample set into an initial multimodal space vector using a pre-trained image-text matching model;
inputting the initial multimodal space vector into the third initial model, to obtain a composite image and a composite latent vector based on the image generating model and a standard latent vector sample in the standard latent vector sample set;
computing a matching degree between the composite image and the descriptive text sample based on the pre-trained image-text matching model;
determining the third initial model as the image editing model, in response to the matching degree being greater than a matching threshold that is pre-set; and
obtaining, in response to the matching degree being less than or equal to the matching threshold, an updated multimodal space vector based on the composite image and the descriptive text sample, and adjusting parameters of the third initial model by using the updated multimodal space vector as the initial multimodal space vector and using the composite latent vector as the standard latent vector sample, to continue training the third initial model.

7. The method according to claim 6, wherein inputting the initial multimodal space vector into the third initial model, to obtain the composite image and the composite latent vector based on the image generating model and the standard latent vector sample in the standard latent vector sample set comprises:
inputting the initial multimodal space vector into the third initial model to obtain a first latent vector deviation value;
correcting the standard latent vector sample with the first latent vector deviation value to obtain the composite latent vector; and
inputting the composite latent vector into the image generating model to obtain the composite image.

8. The method according to claim 1, wherein training the fourth initial model using the third sample data based on the image generating model, the image encoding model, and the image editing model, to obtain the virtual image generating model comprises:
obtaining a target shape coefficient sample set and a target latent vector sample set by using standard image samples in the standard image sample set and descriptive text samples in the descriptive text sample set as input data, based on the image generating model, the image encoding model, and the image editing model;
inputting a target latent vector sample in the target latent vector sample set into the fourth initial model to obtain a test shape coefficient;
obtaining a third loss value based on a target shape coefficient sample, corresponding to the target latent vector sample, in the target shape coefficient sample set and the test shape coefficient;
determining the fourth initial model as the virtual image generating model, in response to the third loss value being less than a third loss threshold that is pre-set; and
adjusting parameters of the fourth initial model in response to the third loss value being greater than or equal to the third loss threshold, to continue training the fourth initial model.

9. The method according to claim 8, wherein obtaining the target shape coefficient sample set and the target latent vector sample set by using the standard image samples in the standard image sample set and the descriptive text samples in the descriptive text sample set as input data, based on the image generating model, the image encoding model, and the image editing model comprises:
inputting the standard image samples into the image encoding model to obtain a standard latent vector sample set;
encoding a standard image sample and a descriptive text sample into a multimodal space vector using a pre-trained image-text matching model;
inputting the multimodal space vector into the image editing model to obtain a second latent vector deviation value;
correcting a standard latent vector sample, corresponding to the standard image sample, in the standard latent vector sample set with the second latent vector deviation value to obtain a target latent vector sample, and obtaining a target latent vector sample for each standard image sample to form the target latent vector sample set;
inputting the target latent vector samples in the target latent vector sample set into the image generating model to obtain images each corresponding to a target latent vector sample; and
inputting the images into a pre-trained shape coefficient generating model, to obtain the target shape coefficient sample set.

10. A method for generating a virtual image using the virtual image generating model of claim 1, the method comprising:
receiving a request for generating a virtual image;
determining a first descriptive text based on the request for generating a virtual image; and
generating a virtual image corresponding to the first descriptive text based on the first descriptive text, a standard image that is pre-set, and the virtual image generating model of claim 1.

11. The method according to claim 10, wherein obtaining the virtual image corresponding to the first descriptive text based on the first descriptive text, the standard image that is pre-set, and the virtual image generating model comprises:
encoding the standard image and the first descriptive text into a multimodal space vector using a pre-trained image-text matching model;
inputting the multimodal space vector into a pre-trained image editing model to obtain a latent vector deviation value;
correcting a latent vector corresponding to the standard image with the latent vector deviation value to obtain a composite latent vector;
inputting the composite latent vector into the virtual image generating model, to obtain a shape coefficient; and
generating the virtual image corresponding to the first descriptive text based on the shape coefficient.

12. The method according to claim 11, wherein the method further comprises:
receiving a request for updating a virtual image;
determining an original shape coefficient and a second descriptive text based on the request for updating a virtual image;
inputting the original shape coefficient into a pre-trained latent vector generating model, to obtain a latent vector corresponding to the original shape coefficient;
inputting the latent vector corresponding to the original shape coefficient into a pre-trained image generating model, to obtain an original image corresponding to the original shape coefficient; and
generating an updated virtual image based on the second descriptive text, the original image, and the virtual image generating model.

13. An apparatus for training a virtual image generating model, comprising:
at least one processor; and
a memory storing instructions, wherein the instructions when executed by the at least one processor, cause the at least one processor to perform operations, the operations comprising:
acquiring a standard image sample set, a descriptive text sample set, and a random vector sample set;
training a first initial model using the standard image sample set and the random vector sample set as first sample data, to obtain an image generating model;
obtaining a test latent vector sample set and a test image sample set based on the random vector sample set and the image generating model;
training a second initial model using the test latent vector sample set and the test image sample set as second sample data, to obtain an image encoding model;
training a third initial model using the standard image sample set and the descriptive text sample set as third sample data, to obtain an image editing model; and
training a fourth initial model using the third sample data based on the image generating model, the image encoding model, and the image editing model, to obtain the virtual image generating model.

14. The apparatus according to claim 13, wherein the operations further comprise:
inputting standard image samples in the standard image sample set into a pre-trained shape coefficient generating model, to obtain a shape coefficient sample set;
inputting the standard image samples in the standard image sample set into the image encoding model to obtain a standard latent vector sample set; and
training a fifth initial model using the shape coefficient sample set and the standard latent vector sample set as fourth sample data, to obtain a latent vector generating model.

15. The apparatus according to claim 13, wherein training the first initial model using the standard image sample set and the random vector sample set as the first sample data, to obtain the image generating model comprises:
inputting a random vector sample in the random vector sample set into a conversion network of the first initial model to obtain a first initial latent vector;
inputting the first initial latent vector into a generation network of the first initial model to obtain an initial image;
obtaining a first loss value based on the initial image and a standard image in the standard image sample set;
determining the first initial model as the image generating model, in response to the first loss value being less than a preset first loss threshold; and
adjusting parameters of the first initial model in response to the first loss value being greater than or equal to the first loss threshold, to continue training the first initial model.

16. The apparatus according to claim 15, wherein obtaining the test latent vector sample set and the test image sample set based on the random vector sample set and the image generating model comprises:
inputting the random vector samples in the random vector sample set into a conversion network of the image generating model to obtain the test latent vector sample set; and
inputting test latent vector samples in the test latent vector sample set into a generation network of the image generating model to obtain the test image sample set.

17. The apparatus according to claim 16, wherein training the second initial model using the test latent vector sample set and the test image sample set as the second sample data, to obtain the image encoding model comprises:
inputting a test image sample in the test image sample set into the second initial model to obtain a second initial latent vector;
obtaining a second loss value based on the second initial latent vector and a test latent vector sample, corresponding to the test image sample, in the test latent vector sample set;
determining the second initial model as the image encoding model, in response to the second loss value being less than a second loss threshold that is pre-set; and
adjusting parameters of the second initial model in response to the second loss value being greater than or equal to the second loss threshold, to continue training the second initial model.

18. The apparatus according to claim 14, wherein training the third initial model using the standard image sample set and the descriptive text sample set as the third sample data, to obtain the image editing model comprises:
encoding a standard image sample in the standard image sample set and a descriptive text sample in the descriptive text sample set into an initial multimodal space vector using a pre-trained image-text matching model;
inputting the initial multimodal space vector into the third initial model, to obtain a composite image and a composite latent vector based on the image generating model and a standard latent vector sample in the standard latent vector sample set;
computing a matching degree between the composite image and the descriptive text sample based on the pre-trained image-text matching model;
determining the third initial model as the image editing model, in response to the matching degree being greater than a matching threshold that is pre-set; and
obtaining, in response to the matching degree being less than or equal to the matching threshold, an updated multimodal space vector based on the composite image and the descriptive text sample, and adjusting parameters of the third initial model by using the updated multimodal space vector as the initial multimodal space vector and using the composite latent vector as the standard latent vector sample, to continue training the third initial model.

19. The apparatus according to claim 18, wherein inputting the initial multimodal space vector into the third initial model, to obtain the composite image and the composite latent vector based on the image generating model and the standard latent vector sample in the standard latent vector sample set comprises:
inputting the initial multimodal space vector into the third initial model to obtain a first latent vector deviation value;
correcting the standard latent vector sample with the first latent vector deviation value to obtain the composite latent vector; and
inputting the composite latent vector into the image generating model to obtain the composite image.

20. A non-transitory computer readable storage medium storing computer instructions, wherein the computer instructions are used for causing the computer to execute operations comprising:
acquiring a standard image sample set, a descriptive text sample set, and a random vector sample set;
training a first initial model using the standard image sample set and the random vector sample set as first sample data, to obtain an image generating model;
obtaining a test latent vector sample set and a test image sample set based on the random vector sample set and the image generating model;
training a second initial model using the test latent vector sample set and the test image sample set as second sample data, to obtain an image encoding model;
training a third initial model using the standard image sample set and the descriptive text sample set as third sample data, to obtain an image editing model; and
training a fourth initial model using the third sample data based on the image generating model, the image encoding model, and the image editing model, to obtain a virtual image generating model.
